(19) United States
(12) Patent Application Publication
(10) Pub. No.: US 2025/0112795 A1
(43) Pub. Date: Apr. 3, 2025

(54) System and Method for Managing Interactions on a Blockchain Network

(71) Applicant: Bank of America Corporation, Charlotte, NC (US)

(72) Inventors: Gowri Sundar Suriyanarayanan, Chennai (IN); Maneesh Kumar Sethia, Hyderabad (IN); Abhijit Behera, Hyderabad (IN)

(21) Appl. No.: 18/477,719

(22) Filed: Sep. 29, 2023

(51) Int. Cl. H04L 9/00

(52) U.S. Cl. CPC H04L 9/50

(57) ABSTRACT

A system is configured to perform an interaction between a first user and a second user. The system comprises memory operable to store a data log comprising information associated with the interaction and a hold duration. The system comprises a processor operably coupled to the memory and a blockchain network. The processor is configured to receive a request from a first user device to record the interaction on the blockchain network, and store information associated with the interaction in a data log. The processor is configured to determine whether a cancel request is received. If received, the processor is configured to cancel the request to record the interaction on the blockchain network. If not received, the processor is configured to hold the request to record the interaction on the blockchain network for the hold duration, and subsequently record the interaction on the blockchain network.

### TECHNICAL FIELD

This disclosure relates generally to data security and network interactions. More particularly, this disclosure relates to a system and method for managing interactions on a blockchain network.

### BACKGROUND

Interactions that are recorded on a blockchain network are considered permanent once confirmed. That is, once an interaction is received by the blockchain network, it is timestamped and embedded into blocks of the blockchain. Blocks are cryptographically secured by a hashing process that links to and incorporates a hash of the previous block. Once the interaction is written to the blockchain, the interaction may not be canceled.

### SUMMARY

The systems and methods in the present disclosure provide practical applications and technical advantages that overcome the current technical problems described herein. As discussed above, once an interaction is received and written to the blockchain, the interaction may not be canceled. One disadvantage of this process is that if a user sends the interaction to a wrong address, the interaction may be lost, as it cannot be canceled or reversed once written to the blockchain. Some interactions on the blockchain are anonymous or pseudonymous, and there may be no way to determine who owns a particular address. The provided systems and methods are integrated into the practical application of allowing a user to submit a cancel request to an entity server before a hold time elapses. For example, the provided systems and methods include an operation of determining whether a blockchain management flag is active or inactive. If the blockchain management flag is inactive, the provided systems and methods record the interaction on the blockchain network. If the blockchain management flag is active, the provided systems and methods include an operation of holding the request to record the interaction on the blockchain network for a hold duration. The provided systems and methods include an operation of determining whether a cancel request is received by the entity server during the hold duration. If the cancel request is received by the entity server, the entity server is configured to cancel the request to record the interaction on the blockchain network such that the interaction is not recorded on the blockchain network. If the cancel request is not received, the entity server is configured to hold the request to record the interaction on the blockchain network for the remainder of the hold duration, after which the interaction is recorded on the blockchain network. The provided systems and methods further include an operation of determining whether a force push request is received before the hold duration expires. If the force push request is received, the entity server is configured to record the interaction on the blockchain network before the hold duration expires. If the force push request is not received, the entity server is configured to record the interaction on the blockchain network after the hold duration expires. Accordingly, the present disclosure provides an opportunity to cancel an interaction before it is recorded in the blockchain network.

The disclosed systems and methods provide several practical applications and technical advantages. First, the disclosed systems and methods provide improved data security by allowing users to cancel interactions from being recorded on the blockchain before the interaction is irreversibly recorded. Allowing the user to cancel the interaction reduces the chance of losing data associated with the interaction if it is accidentally sent to the wrong address, thereby improving data security for the user. Second, the disclosed systems and methods provide an improvement to the underlying technology via the entity server which is configured to provide the user with an option to cancel the request to record the interaction on the blockchain. Previously, any request sent to the blockchain was immediately received and recorded by the blockchain with no option to row back the request. This allows the user to have an option to cancel the request, so that the interaction is not accidentally sent to the wrong address on the blockchain. By allowing the user to cancel a request to record an interaction on the blockchain before it is recorded, the system and method of the present disclosure saves valuable computer, memory, and networking resources that would otherwise be spent trying to correct the erroneous recording.

In some embodiments, the present disclosure provides a system configured to perform an interaction between a first user and a second user. The system comprises a memory operable to store a data log comprising information associated with the interaction. The memory is also operable to store a hold duration. In some embodiments, the system comprises a processor operably coupled to the memory and a blockchain network. The processor is configured to receive a request from a first user device to record the interaction between the first user and the second user on the blockchain network. The processor is configured to store information associated with the interaction in the data log in the memory, and determine whether a cancel request is received. If the cancel request is received, the processor is configured to cancel the request to record the interaction on the blockchain network. If the cancel request is not received, the processor is configured to hold the request to record the interaction on the blockchain network for the hold duration, and subsequently record the interaction on the blockchain network.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a system according to an embodiment of the present disclosure; and

FIG. 2 illustrates a flowchart of one embodiment of a method of operating the system of FIG. 1.

### DETAILED DESCRIPTION

As described above, once an interaction is received and written to the blockchain, the interaction may not be canceled. One disadvantage of this process is that if a user sends the interaction to a wrong address, the interaction may be lost, as it cannot be canceled or reversed once written to the blockchain. Some interactions on the blockchain are anonymous or pseudonymous, and there may be no way to determine who owns a particular address. The provided systems and methods are integrated into the practical application of allowing a user to submit a cancel request to an entity server before a hold time elapses. For example, the provided systems and methods include an operation of determining whether a blockchain management flag is active or inactive. If the blockchain management flag is inactive, the provided systems and methods record the interaction on the blockchain network. If the blockchain management flag is active, the provided systems and methods include an operation of holding the request to record the interaction on the blockchain network for a hold duration. The provided systems and methods include an operation of determining whether a cancel request is received by the entity server during the hold duration. If the cancel request is received by the entity server, the entity server is configured to cancel the request to record the interaction on the blockchain network such that the interaction is not recorded on the blockchain network. If the cancel request is not received, the entity server is configured to hold the request to record the interaction on the blockchain network for the remainder of the hold duration, after which the interaction is recorded on the blockchain network. The provided systems and methods further include an operation of determining whether a force push request is received before the hold duration expires. If the force push request is received, the entity server is configured to record the interaction on the blockchain network before the hold duration expires. If the force push request is not received, the entity server is configured to record the interaction on the blockchain network after the hold duration expires. Accordingly, the present disclosure provides an opportunity to cancel an interaction before it is recorded in the blockchain network.

### System Overview:

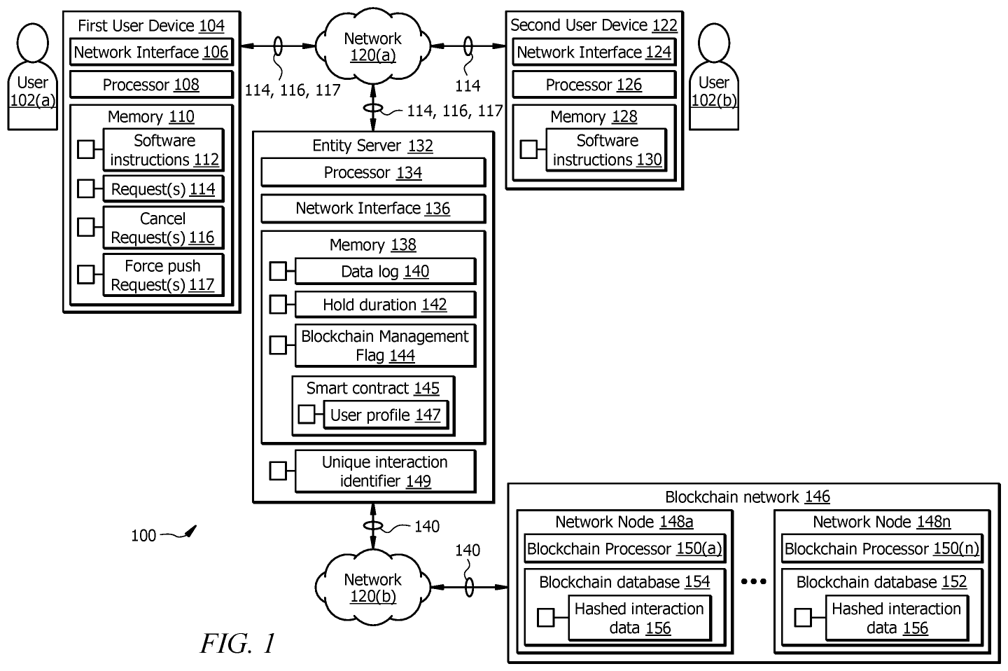

FIG. 1 illustrates a system 100 that is configured to perform an interaction between a first user 102a operating a first user device 104 and a second user 102b operating a second user device 122. In some embodiments, the system 100 comprises a first user device 104, one or more networks 120(a)-(b), a second user device 122, an entity server 132, and a blockchain network 146. In general, the blockchain network 146 comprises a plurality of network nodes 148(a)-(n) that form a distributed network configured to maintain a blockchain 154, where each network node 148(a)-(n) of the blockchain network 146 comprises a blockchain processor 150(a)-(n) configured to distribute hashed interaction data 156 among the plurality of network nodes 148(a)-(n). The entity server 132 comprises a memory 138 operable to store a data log 140 comprising information associated with the interaction. The memory 138 is also configured to store a hold duration 142. In some embodiments, the entity server 132 comprises a processor 134 operably coupled to the memory 138 and the blockchain network 146. The processor 134 is configured to receive a request 114 from the first user device 104 to record the interaction between the first user device 104 and the second user device 122 on the blockchain network 146. The processor 134 is configured to store information associated with the interaction in the data log 140 in the memory 138. The processor 134 is configured to determine whether a blockchain management flag 144 is active. If the blockchain management flag 144 is inactive, the processor 134 is configured to record the interaction on the blockchain network 146. If the blockchain management flag 144 is active, the processor 134 is configured to hold the request 114 to record the interaction on the blockchain network 146 for a hold duration 142. The processor 134 is configured to determine whether a cancel request 116 is received during the hold duration 142. If the cancel request 116 is received, the processor 134 is configured to cancel the request 114 to record the interaction on the blockchain network 146 such that the interaction is not recorded on the blockchain network 144. If the cancel request 116 is not received, the processor 134 is configured to hold the request to record the interaction on the blockchain network 146 for the remainder of the hold duration 142. The processor 134 is further configured to determine whether a force push request 117 is received before the hold duration 142 expires. If the force push request 117 is received, the processor 134 is configured to record the interaction on the blockchain network 146 before the hold duration 142 expires. If the force push request is not received, the processor 134 is configured to record the interaction on the blockchain network after the hold duration 142 expires.

### System Components

### User Device(s)

The first user device 104 may be any device configured to interact with a first user 102(a) and configured to receive a request 114 from the first user 102(a) to perform an interaction between the first user device 104 and the second user device 122. Similarly, the second user device 122 may be any device configured to interact with a second user 102(b). For example, the interaction may refer to a transfer of data between the first user device 104 and the second user device 122, which is to be recorded on the blockchain network 146. In one non-limiting example, the interaction may refer to data (e.g., transaction) records performed between the first user device 104 and the second user device 122, which is to be recorded on the blockchain network 146 (e.g., record data associated with the acquisition of cryptocurrency, data associated with smart contracts, data associated with non-fungible tokens, etch).

The first user device 104 and the second user device 122 may be a mobile phone, a smartphone, an electronic tablet device, or a computer (e.g., personal computer, desktop, workstation, laptop). In some embodiments, the first user device 104 and the second user device 122 are in signal communication with an entity server 132 via network 120(a). The first user device 104 and the second user device 122 may include a suitable user interface. The user interface may include a display for displaying information. The user interface may optionally include other terminal equipment that allows the respective user 102(a), 102(b) to interact with the first user device 104 and the second user device 122, which may include, but is not limited to, a mouse, a touchscreen, a keyboard, and the like. In some embodiments, the first user device 104 may comprise a network interface 106, a processor 108, and a memory 110. Similarly, the second user device 122 may similarly include a network interface 124, a processor 126, and a memory 128.

The network interfaces 106, 124 are configured to enable wired and/or wireless communications between the network 120(a) and the respective first user device 104 and the second user device 122, as well as other components in the system 100. Suitable network interfaces 106, 124 include, but are not limited to, an near field communication (NFC) interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The network interfaces 106, 124 may be configured to use any suitable type of communication protocol as would be appreciated by one of ordinary skill in the art.

The processors 108, 126 are configured to send and receive data using the respective network interface 106, 124. The processors 108, 126 are operatively coupled to a respective memory 110, 128. Each memory 110, 128 may be a non-transitory computer readable medium. For example, each memory 110, 128 may be volatile or non-volatile and may comprise a read-only memory (ROM), random-access memory (RAM), ternary content-addressable memory (TCAM), dynamic random-access memory (DRAM), and static random-access memory (SRAM). Each memory 110, 128 may be implemented using one or more disks, tape drives, solid-state drives, and/or the like.

The first memory 110 is operable to store software instructions 112, a request 114 that is configured to communicate with the entity server 132 to record the interaction on the blockchain network 146, a cancel request 116 that is configured to communicate with the entity server 132 to cancel the request 114 to record the interaction on the blockchain network 146, and a force push request 117 that is configured to communicate with the entity server 132 to cancel a hold duration 142 and record the interaction on the blockchain network 146. The software instructions 112 may comprise any suitable set of instructions, logic rules or code operable to execute the processor 108 to perform the operations of the first user device 104 described herein. In particular, the software instructions 112 may include code for executing the request 114, the cancel request 116, and the force push request 117, and for communicating the request 114, the cancel request 116, and the force push request 117 to the entity server 132. Similarly, the memory 128 may include software instructions 130. The software instructions 130 may comprise any suitable set of instructions, logic rules or code operable to execute the processor 126 to perform the operations of the second user device 122 described herein. In particular, the software instructions 130 may include instructions for communication data associated with the interaction to the first user device 104.

Each processor 108, 126 may be any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, each processor 108, 126 may be implemented in cloud devices, servers, virtual machines, and the like. Each processor 108, 126 may be a programmable logic device, a microcontroller, a microprocessor, or any suitable combination of the preceding. Each processor 108, 126 is configured to process data and may be implemented in hardware or software. For example, each processor 108, 126 may be 8-bit, 16-bit, 32-bit, 64-bit, or of any other suitable architecture. Each processor 108, 126 may include an arithmetic logic unit (ALU) for performing arithmetic and logic operations, registers the supply operands to the ALU and store the results of ALU operations, and a control unit that fetches instructions from the respective memory 110, 128 and executes them by directing the coordinated operations of the ALU, registers and other components. Each processor 108, 126 is configured to implement various instructions described herein. For example, each processor 108, 126 is configured to execute instructions from the respective memory 110, 128 (e.g., software instructions 112, 130) to implement the functions of each processor 108, 126. In this way, each processor 108, 126 may be a special-purpose computer designed to implement the functions disclosed herein. In an embodiment, each processor 108, 126 is implemented using logic units, FPGAs, ASICs, DSPs, or any other suitable hardware.

### Network

Network 120(a)-120(b) may be any suitable type of wireless and/or wired network, including, but not limited to, all or a portion of the Internet, an Intranet, a private network, a public network, a peer-to-peer network, the public switched telephone network, a cellular network, a local area network (LAN), a metropolitan area network (MAN), a wide area network (WAN), and a satellite network. The network 120(a)-(b) may be configured to support any suitable type of communication protocol as would be appreciated by one of ordinary skill in the art. In some embodiments, the network 120(a) facilitates the transfer of data between the first user device 104, the second user device 122, and the entity server 132. In some embodiments, the network 120(b) facilitates the transfer of data between the entity server 132 and the blockchain network 146. Although depicted as two networks in FIG. 1, networks 120(a)-(b) may be a single network.

### Entity Server

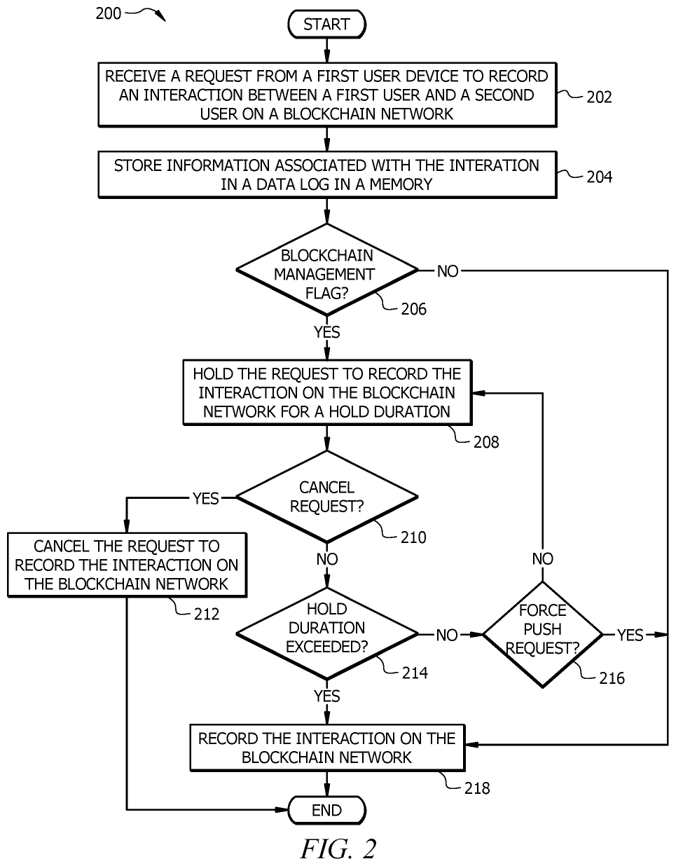

The entity server 132 comprises a processor 134 operably coupled with a network interface 136 and a memory 138. The processor 134 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors may be implemented in cloud devices, servers, virtual machines, and the like. The processor 134 may be a programmable logic device, a microcontroller, a microprocessor, or any suitable number and combination of the preceding. The one or more processors are configured to process data and may be implemented in hardware or software. For example, the processor 134 may be 8-bit, 16-bit, 32-bit, 64-bit, or of any other suitable architecture. The processor 134 may include an arithmetic logic unit (ALU) for performing arithmetic and logic operations. The processor 134 may register the supply operands to the ALU and store the results of ALU operations. The processor 134 may further include a control unit that fetches instructions from memory and executes them by directing the coordinated operations of the ALU, registers, and other components. The one or more processors are configured to implement various software instructions. In this way, processor 134 may be a special-purpose computer designed to implement the functions disclosed herein. In an embodiment, the processor 134 is implemented using logic units, FPGAs, ASICs, DSPs, or any other suitable hardware. The processor 134 is configured to operate as described in FIGS. 1-2. For example, the processor 134 may be configured to perform one or more operations of the operational flow 200 as described in FIG. 2.

The network interface 136 configured to enable wired and/or wireless communications between the entity server 132 and the network 120(a)-(b), as well as other components in the system 100. Suitable network interfaces 136 include an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The network interface 136 may be configured to use any suitable type of communication protocol as would be appreciated by one of ordinary skill in the art.

The memory 138 may be volatile or non-volatile and may comprise read-only memory (ROM), random-access memory (RAM), ternary content-addressable memory (TCAM), dynamic random-access memory (DRAM), and static random-access memory (SRAM). The memory 138 may include one or more of a local database, cloud database, network-attached storage (NAS), etc. The memory 138 comprises one or more disks, tape drives, or solid-state drives, and may be used as an over-flow data storage device, to store programs when such programs are selected for execution, and to store instructions and data that are read during program execution. The memory 138 may store any of the information described in FIGS. 1-2 along with any other data, instructions, logic, rules, or code operable to implement the function(s) described herein when executed by processor 134.

The memory 138 is operable to store a data log 140 that comprises information associated with the interaction. For example, the interaction may refer to a transfer of data between the first user device 104 and the second user device 122. The data log 140 may include any information associated with the transfer of data. For example, the information associated with the interaction may include, but is not limited to, a data amount (e.g., transaction amount), a time stamp of the interaction, information associated with the acquisition of cryptocurrency, information associated with smart contracts, and information associated with non-fungible tokens. In some embodiments the processor 134 may be configured to generate a unique interaction identifier 149 associated with the interaction, where the unique interaction identifier 149 comprises at least one of a time stamp of the interaction and the data amount. The unique interaction identifier 149 may be stored in the data log 140. The unique interaction identifier 149 may be generation using a hashing function, which may include, for example, cyclic redundancy checks, checksums, non-cryptographic hash functions, keyed cryptographic hash functions, and unkeyed cryptographic hash functions.

The memory 138 is operable to store a hold duration 142. In some embodiments, if the blockchain management flag 144 is active, the processor 134 is configured to execute the hold duration 142 from the memory 138 to hold the request 114 to record the interaction on the blockchain network 146 for the hold duration 142, as described above. In some embodiments, the memory 138 is operable to store a smart contract 145 that comprises one or more user profile 147 for the first user 102(a). The user profile 147 may be configured to customize a duration of the hold duration 142 to any desired duration. For example, the user profile 147 may include a unique hold duration that is customized in duration for the first user 102(a). The duration of the hold duration may be customized to any duration, e.g., at least a minute, at least 5 minutes, at least 30 minutes, at least one hour, to less than one day, less than a week, etc.

In some embodiments, the memory 138 is operable to store a blockchain management flag 144. The blockchain management flag 144 may be set to an active state or an inactive state. If the blockchain management flag 144 is inactive, the processor 134 is configured to record the interaction on the blockchain network 146. If the blockchain management flag 144 is active, the processor 134 is configured to hold the request 114 to record the interaction on the blockchain network 146 for the hold duration 142. The processor 134 is further configured to determine whether a cancel request 116 is received before the hold duration 142 expires. If the cancel request 116 is received, the processor 134 is configured to cancel the request 114 to record the interaction on the blockchain network 146 such that the interaction is not recorded on the blockchain network 146. If the cancel request 116 is not received, the processor 134 is configured to hold the request 114 to record the interaction on the blockchain network 146 for the hold duration 142. The processor 134 is further configured to determine whether a force push request 117 is received before the hold duration 142 expires. If the force push request 117 is received, the processor 134 is configured to record the interaction on the blockchain network 146 before the hold duration 142 expires. If the force push request 117 is not received, the processor 134 is configured to record the interaction on the blockchain network 146 after the hold duration 142 expires.

### Blockchain Network

The blockchain network 146 is a peer-to-peer network of network nodes 148(a)-(n), and is generally configured to distribute data from the data log 140 as hashed interaction data 156 among the network nodes 146(a)-(n). The hashed interaction data 156 may include information and/or data from the data log 140 that is hashed using a hashing function. The hashing function may include, for example, cyclic redundancy checks, checksums, non-cryptographic hash functions, keyed cryptographic hash functions, and unkeyed cryptographic hash functions. In some embodiments, the blockchain network 146 is a distributed database in a network of network nodes 148(a)-(n). In some embodiments, blockchain network 146 may be a public blockchain network. In some embodiments, blockchain network 146 may be a private blockchain network. For example, membership in the blockchain network 146 may be limited to nodes registered as belonging to and/or affiliated with the organization to which the network 120(b) belongs.

The blockchain network 146 may comprise any number of network nodes 148(a)-(n) to form a distributed network that maintains a blockchain 154. Each network node 148(a)-(n) may comprise a computing device, a virtual machine, a server, a workstation, and/or the like. Each network node 148(a)-(n) of the blockchain network 146 stores a blockchain database 152 that is configured to store a copy of the blockchain 154. Each network node may include a blockchain processor 150(a)-(n) configured to perform any of the functions or actions of the network node 148(a)-(n) described herein. The blockchain processor 150 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, the blockchain processor 150(a)-(n) may be implemented in cloud devices, servers, virtual machines, and the like. The blockchain processor 150(a)-(n) may be a programmable logic device, a microcontroller, a microprocessor, or any suitable combination of the preceding. The blockchain processor 150(a)-(n) is configured to process data and may be implemented in hardware or software. For example, the blockchain processor 150(a)-(n) may be 8-bit, 16-bit, 32-bit, 64-bit, or of any other suitable architecture. The blockchain processor 150(a)-(n) may include an arithmetic logic unit (ALU) for performing arithmetic and logic operations, registers the supply operands to the ALU and store the results of ALU operations, and a control unit that fetches instructions from the blockchain database 152 and executes them by directing the coordinated operations of the ALU, registers and other components. The blockchain processor 150(a)-(n) is configured to implement various instructions described herein. In this way, blockchain processor 150(a)-(n) may be a special-purpose computer designed to implement the functions disclosed herein. In an embodiment, the blockchain processor 150(a)-(n) is implemented using logic units, FPGAs, ASICs, DSPs, or any other suitable hardware.

In some embodiments, the blockchain processor 150(a)-(n) is configured to establish consensus among the network nodes 148(a)-(n) about the present state of the blockchain database 152. For example, the blockchain processor 150(a)-(n) may communicate with each respective network node 148(a)-(n) to implement a consensus protocol procedure through which all the network nodes 148(a)-(n) of the blockchain network 146 reach a common agreement about the present state of the blockchain database 152. In this way, each network node 148(a)-(n) achieves reliability in the blockchain network 146 and establishes trust between the network nodes 148(a)-(n) in a distributed computing environment. Essentially, the consensus protocol makes sure that every new block that is added to the blockchain 154 is the one and only version of the truth that is agreed upon by all the blocks in the blockchain 154. Blockchain 154 links together blocks of data, which store identifiable units called blockchain data entries. The blockchain data entry may be interchangeably referred to herein as a blockchain data entry. The blockchain data entries stored in the blockchain 154, may include information, files, and/or any other suitable type of data. For example, blockchain data entries may include data from the data log 140 stored as hashed interaction data 156.

### System Operation

FIG. 2 illustrates one embodiment of an operational flow 200 for using an entity server 132 for performing an interaction between a first user device 104 and a second user device 122. The operational flow 200 can be logically described in three parts. The first part includes operations 202-206, which are generally directed to receiving a request 114 from a first user device 104 to record an interaction between a first user device 104 and a second user device 122 on a blockchain network 146, storing information associated with the interaction in a data log 140 in the memory 138 of the entity server 132, and determining whether a blockchain management flag 144 is active or inactive. If the blockchain management flag 144 is inactive, the operational flow 200 proceeds to operation 218 to record the interaction on the blockchain network 146. If the blockchain management flag 144 is active, the operational flow 200 proceeds to the second part. The second part includes operations 208-214, which includes holding the request 114 to record the interaction on the blockchain network 146 for a hold duration 142, determining whether the entity server 132 receives a cancel request 116 before the hold duration 142 expires, and if the cancel request 116 is received, cancelling the request 114 to record the interaction on the blockchain network 146. If the cancel request 116 is not received, the operational flow proceeds to the third part. The third part includes operations 216-218, which generally includes determining whether a force push request 117 is received before the hold duration 142 expires. If the force push request 117 is received, the entity server 132 is configured to record the interaction on the blockchain network 146 before the hold duration 142 expires. If the force push request 117 is not received, the entity server 132 is configured to record the interaction on the blockchain network 146 after the hold duration 142 expires.

In operation, the operational flow 200 may begin at operation 202 where the entity server 132 receives a request 114 to record an interaction between the first user device 104 and the second user device 122. For example, the interaction may refer to a transfer of data between the first user device 104 and the second user device 122, which is to be recorded on the blockchain network 146. In one non-limiting example, the interaction may refer to data (e.g., transaction) records performed between the first user device 104 and the second user device 122, which is to be recorded on the blockchain network 146 (e.g., record data associated with the acquisition of cryptocurrency, data associated with smart contracts, data associated with non-fungible tokens, etc).

At operation 204, the operational flow 200 includes storing information associated with the interaction in a data log 140 in the memory 138 of the entity server 132. The data log 140 may include any information associated with the transfer of data. For example, the information associated with the interaction may include, but is not limited to, a data amount, a time stamp of the interaction, information associated with the acquisition of cryptocurrency, information associated with smart contracts, and information associated with non-fungible tokens.

At operation 206, the operational flow 200 includes determining whether a blockchain management flag 144 is active or inactive. If the blockchain management flag 144 is inactive, the operational flow 200 proceeds to operation 218 where the interaction between the first user device 104 and the second user device 122 is recorded on the blockchain network 146. For example, in one exemplary use case where the blockchain management flag 144 is set to inactive, the entity server 132 may receive a second request from the first user device 104 to record a second interaction between the first user device 104 and the second user device 122 on the blockchain network 146. The entity server 132 may store the information associated with the second interaction in the data log 140 in the memory, and once the entity server 132 determines that the blockchain management flag 144 is inactive, the entity server 132 may record the second interaction on the blockchain network 146. For example, when the blockchain management flag 144 is inactive, the operational flow 200 may bypass operations 208-216 to record the interaction on the blockchain network 146. If the blockchain management flag 144 is active, the operational flow 200 proceeds to operation 208.

At operation 208, the operational flow 200 includes holding the request 114 to record the interaction on the blockchain network 146 for a hold duration 142. During operation 208, the entity server 132 may record a unique interaction identifier 149 associated with the interaction. The unique interaction identifier 149 may comprise at least one of a time stamp of the interaction and a data amount associated with the interaction. The unique interaction identifier 149 may be hashed, using the hashing functions described above. The unique interaction identifier 149 may be stored in the data log 140 of the memory 138 in the entity server 132. The hold duration 142 in operation 208 may be any suitable duration. For example, the entity server 132 may store a smart contract 145 that comprises one or more user profile 147 for the first user 102(a). The user profile 147 may be configured to customize a duration of the hold duration 142 to any desired duration. For example, the user profile 147 may include a unique hold duration that is customized in duration for the first user 102(a). The duration of the hold duration may be customized to any duration, e.g., at least a minute, at least 5 minutes, at least 30 minutes, at least one hour, to less than one day, less than a week, etc.

At operation 210, the operational flow 200 includes determining whether the entity server 132 has received a cancel request 116. If the cancel request 116 is received, the operational flow 200 proceeds to operation 212 to cancel the request 114 to record the interaction on the blockchain network 146. If the cancel request 116 is not received, the operational flow 200 proceeds to operation 214. Operation 214 includes determining whether the hold duration 142 is exceeded. If the hold duration is not exceeded, the operational flow 200 proceeds to operation 216. Operation 216 includes determining whether a force push request 117 has been received. If the force push request 117 is received, the entity server 132 is configured to record the interaction on the blockchain network 146 before the hold duration 142 expires. If a force push request 117 is not received, the operational flow 200 may recycle back to repeat operations 208-214. If the hold duration 142 from operation 214 is exceeded, the operational flow proceeds to operation 218 to record the interaction on the blockchain network 146.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system configured to perform an interaction between a first user and a second user, the system comprising:
a blockchain network comprising a plurality of network nodes that form a distributed network configured to maintain a blockchain, each network node of the blockchain network comprising a blockchain processor configured to distribute hashed interaction data among the plurality of network nodes; and
an entity server comprising:
a memory operable to store a data log comprising information associated with the interaction and a hold duration;
a processor operably coupled to the memory and the blockchain network, wherein the processor is configured to:
receive a request from a first user device to record the interaction between the first user and the second user on the blockchain network;
store information associated with the interaction in the data log in the memory; and
determine whether a cancel request is received, wherein: (i) if the cancel request is received, the processor is configured to cancel the request to record the interaction on the blockchain network, and (ii) if the cancel request is not received, the processor is configured to hold the request to record the interaction on the blockchain network for the hold duration, and subsequently record the interaction on the blockchain network.

2. The system of claim 1, wherein the memory is configured to store a blockchain management flag, wherein the blockchain management flag is active and the processor is further configured to:
determine that the cancel request is not received; and
record the interaction on the blockchain network after the hold duration expires.

3. The system of claim 1, wherein the processor is further configured to:
determine that the cancel request is not received;
hold the request to record the interaction for at least a portion of the hold duration, wherein before the hold duration expires, the processor is further configured to:
determine whether a force push request is received, wherein:
(i) if the force push request is received, the processor is configured to record the interaction on the blockchain network before the hold duration expires, and
(ii) if the force push request is not received, the processor is configured to record the interaction on the blockchain network after the hold duration expires.

4. The system of claim 1, wherein when the processor stores the data log comprising information associated with the interaction in the memory, the processor is further configured to:
record a unique interaction identifier associated with the interaction, wherein the unique interaction identifier comprises at least one of a time stamp of the interaction and a data amount; and
store the unique interaction identifier in the memory.

5. The system of claim 1, wherein the memory is further configured to store a blockchain management flag, wherein the blockchain management flag is inactive, and the processor is further configured to:
receive a second request from a first user to record a second interaction between the first user and the second user on the blockchain network;
store information associated with the second interaction in the data log in the memory;
determine that the blockchain management flag is inactive; and
record the second interaction on the blockchain network.

6. The system of claim 1, wherein the memory is operable to store a smart contract, wherein the smart contract comprises a user profile for the first user, wherein the user profile includes a unique hold duration for the first user that is used for the hold duration.

7. The system of claim 1, wherein the processor is further configured to:
determine that the cancel request is received; and
cancel the request to record the request to record the interaction on the blockchain network such that the interaction is not recorded on the blockchain network.

8. The system of claim 1, wherein the processor is further configured to:
determine that the cancel request is not received;
hold the request to record the interaction for the hold duration; and
record the interaction on the blockchain network after the hold duration expires.

9. A method of using an entity server for performing an interaction between a first user and a second user, the method comprising:
receiving a request on the entity server from a first user device to record the interaction between the first user and the second user on a blockchain network;
storing, using the entity server, information associated with the interaction in a data log within a memory; and
determining whether the entity server receives a cancel request, wherein:
(i) if the cancel request is received, the entity server is configured to cancel the request to record the interaction on the blockchain network, and
(ii) if the cancel request is not received, the entity server is configured to hold the request to record the interaction on the blockchain network for a hold duration, and subsequently record the interaction on the blockchain network.

10. The method of claim 9, wherein a blockchain management flag is active, and wherein the method further comprises:
determining that the cancel request is not received; and
recording the interaction on the blockchain network after the hold duration expires.

11. The method of claim 9, wherein the method further comprises:
determining, using the entity server, that the cancel request is not received;
holding, using the entity server, the request to record the interaction for at least a portion of the hold duration, wherein before the hold duration expires, the method further comprises:
determining, using the entity server, whether a force push request is received, wherein:
(i) if the force push request is received, the entity server is configured to record the interaction on the blockchain network before the hold duration expires, and
(ii) if the force push request is not received, the entity server is configured to record the interaction on the blockchain network after the hold duration expires.

12. The method of claim 9, wherein when the entity server stores the data log comprising information associated with the interaction in the memory, the method further comprises:
recording, using the entity server, a unique interaction identifier associated with the interaction, wherein the unique interaction identifier comprises at least one of a time stamp of the interaction and a data amount; and
storing, using the entity server, the unique interaction identifier in the memory.

13. The method of claim 9, wherein a blockchain management flag is inactive, and the method further comprises:
receiving a second request on the entity server from the first user device to record a second interaction between the first user and the second user on the blockchain network;
storing, using the entity server, information associated with the second interaction in the data log in the memory;
determining, using the entity server, that the blockchain management flag is inactive; and
recording, using the entity server, the second interaction on the blockchain network.

14. The method of claim 9, wherein the memory is operable to store a smart contract, wherein the smart contract comprises a user profile for the first user, wherein the user profile includes a unique hold duration for the first user that is used for the hold duration.

15. The method of claim 9 further comprising:
determining, using the entity server, that the cancel request is received; and
canceling, using the entity server, the request to record the request to record the interaction on the blockchain network such that the interaction is not recorded on the blockchain network.

16. The method of claim 9 further comprising:
determining, using the entity server, that the cancel request is not received;
holding, using the entity server, the request to record the interaction for the hold duration; and
recording, using the entity server, the interaction on the blockchain network after the hold duration expires.

17. A system configured to perform an interaction between a first user and a second user, the system comprising:
a memory operable to store a data log comprising information associated with the interaction and a hold duration;
a processor operably coupled to the memory and a blockchain network, wherein the processor is configured to:
receive a request from a first user device to record the interaction between the first user and the second user on the blockchain network;
store information associated with the interaction in the data log in the memory; and
determine whether a cancel request is received, wherein: (i) if the cancel request is received, the processor is configured to cancel the request to record the interaction on the blockchain network, and (ii) if the cancel request is not received, the processor is configured to hold the request to record the interaction on the blockchain network for the hold duration, and subsequently record the interaction on the blockchain network.

18. The system of claim 17, wherein the memory is configured to store a blockchain management flag, wherein the blockchain management flag is active and the processor is further configured to:
determine that the cancel request is not received; and
record the interaction on the blockchain network after the hold duration expires.

19. The system of claim 17, wherein the processor is further configured to:
determine that the cancel request is not received;
hold the request to record the interaction for at least a portion of the hold duration, wherein before the hold duration expires, the processor is further configured to:
determine whether a force push request is received, wherein:
(i) if the force push request is received, the processor is configured to record the interaction on the blockchain network before the hold duration expires, and
(ii) if the force push request is not received, the processor is configured to record the interaction on the blockchain network after the hold duration expires.

20. the system of claim 17, wherein the memory is further configured to store a blockchain management flag, wherein the blockchain management flag is inactive, and the processor is further configured to:
receive a second request from a first user to record a second interaction between the first user and the second user on the blockchain network;
store information associated with the second interaction in the data log in the memory;
determine that the blockchain management flag is inactive; and
record the second interaction on the blockchain network.
